(19) United States
(12) Patent Application Publication
(10) Pub. No.: US 2024/0317176 A1
(43) Pub. Date: Sep. 26, 2024

(54) HOUSING DEVICE

(71) Applicant: KABUSHIKI KAISHA TOKAI RIKA DENKI SEISAKUSHO, Aichi (JP)

(72) Inventors: Yoshiyuki OYA, Aichi (JP); Masaaki MORIYAMA, Aichi (JP)

(73) Assignee: KABUSHIKI KAISHA TOKAI RIKA DENKI SEISAKUSHO, Aichi (JP)

(21) Appl. No.: 18/606,456

(22) Filed: Mar. 15, 2024

(30) Foreign Application Priority Data
Mar. 20, 2023 (JP) 2023-044283

(51) Int. Cl. B60R 25/24

(52) U.S. Cl. CPC B60R 25/24

(57) ABSTRACT

A housing defines a space in which a portable device for remotely controlling a first controlled device with actuation of a movable member is to be housed. By opening the reclosable body, a second controlled device is enabled to be used with the portable device removed from the housing. In response to reception of an instruction from a mobile device adapted to be carried by a user, the first actuator is caused to actuate the movable portion while the second actuator is caused to disable the opening of the reclosable body. In response to reception of data indicative of a fact that the user satisfies a requirement for use of the second controlled device, the second actuator is caused to enable the opening of the reclosable body.

### CROSS-REFERENCE TO RELATED APPLICATION

The present application is based on Japanese Patent Application No. 2023-044283 filed on Mar. 20, 2023, the entire contents of which are incorporated herein by reference.

### BACKGROUND

The presently disclosed subject matter relates to a housing device equipped with a housing defining a space in which a portable device associated with the use of multiple controlled devices is housed.

European Patent Publication No. 3418985 A1 discloses a housing device adapted to be disposed in a vehicle cabin opened and closed by a door of a vehicle. The housing device includes a housing, a transceiver, and an actuator. The housing defines a space in which an electronic key, which is an example of the portable device, is housed. The electronic key is a device for causing a locking/unlocking device installed in the vehicle to unlock the door through wireless communication when a specific operation is performed. When the transceiver receives an unlocking instruction from a mobile device adapted to be carried by a user, the actuator performs the specific operation described above with respect to the electronic key. As a result, in a state that the electronic key is left in the vehicle cabin, it is possible to remotely control the operation of the locking/unlocking device with the mobile device from, for example, the outside of the vehicle cabin.

### SUMMARY

It is demanded to enhance the convenience of a housing device equipped with a housing defining a space in which a portable device associated with the use of multiple controlled devices is housed.

An illustrative aspect of the presently disclosed subject matter provides a housing device, comprising:
a housing defining a space in which a portable device for remotely controlling a first controlled device with actuation of a movable member is to be housed;
a reclosable body configured to be opened to enable the portable device removed from the space to use a second controlled device;
a first actuator disposed in the housing, and configured to actuate the movable member of the portable device housed in the space;
a second actuator disposed in the housing, and configured to enable/disable opening of the reclosable body;
an interface configured to receive, via wireless communication, an instruction transmitted from a mobile device adapted to be carried by a user as well as data indicative of whether the user satisfies a requirement for use of the second controlled device; and
a processor configured to control operations of the first actuator and the second actuator in accordance with at least one of the instruction and the data,
wherein the processor is further configured to:
   cause the first actuator to actuate the movable portion while causing the second actuator to disable the opening of the reclosable body in a case where the interface receives the instruction; and
   cause the second actuator to enable the opening of the reclosable body in a case where the data is indicative of a fact that the user satisfies the requirement for use.

According to the configuration of the above illustrative aspect, since the opening of the reclosable body is disabled in a case where a user fails to satisfy a requirement for use, the portable device cannot be removed from the housing, so that the second controlled device can be restricted from being used by the user. On the other hand, even in a state where the opening of the reclosable body is disabled, since the actuation of the movable portion of the portable device by the first actuator is allowed, the use of the first controlled device is permitted regardless of whether the user satisfies the requirement for use. As a result, it is possible to alleviate the restriction as for the way of using the portable device associated with the use of the multiple controlled device, so that it is possible to enhance the convenience of the housing device equipped with the housing defining the space in which the portable device is housed.

### DESCRIPTION OF THE DRAWINGS

FIG. 1 illustrates a configuration of a remote control system according to one exemplary embodiment.

FIG. 2 illustrates a configuration of a housing device of FIG. 1.

FIG. 3 illustrates an exemplary operation of the housing device of FIG. 2.

FIG. 4 illustrates a configuration of a housing device of FIG. 1.

FIG. 5 illustrates a configuration of a controller of FIG. 2.

FIG. 6 illustrates an exemplary operation of the housing device of FIG. 2.

FIG. 7 illustrates an exemplary operation of the housing device of FIG. 2.

FIG. 8 illustrates an exemplary operation of the housing device of FIG. 2.

FIG. 9 illustrates an exemplary flow of processing executed by the controller of FIG. 5.

### DESCRIPTION OF EMBODIMENTS

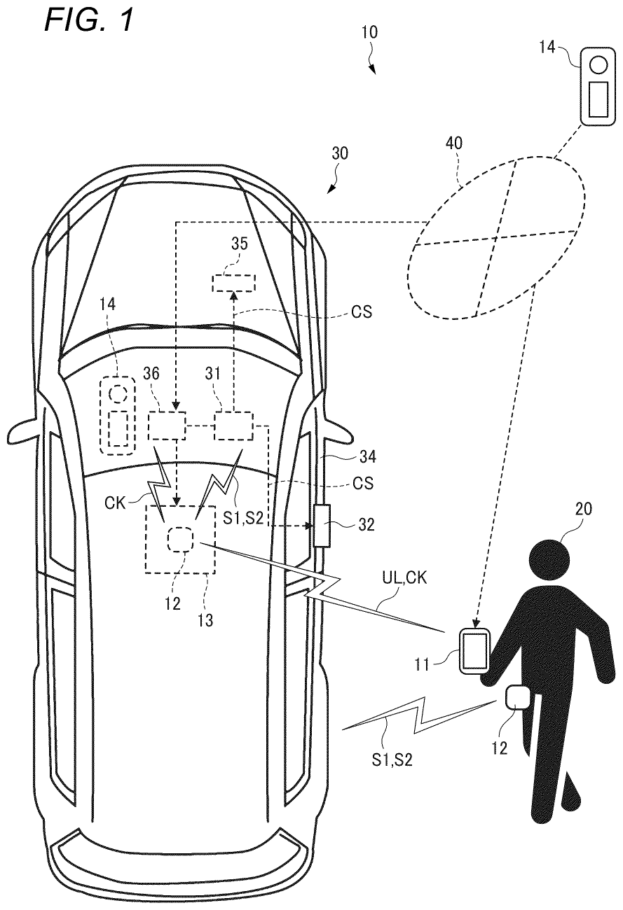

Exemplary embodiments will be described in detail below with reference to the accompanying drawings. FIG. 1 illustrates a configuration of a remote control system 10 according to an exemplary embodiment. In each of the drawings, the scale is appropriately changed in order to make each element illustrated have a recognizable size.

The remote control system 10 includes a mobile device 11. The mobile device 11 is a device adapted to be carried by a user 20. Examples of the mobile device 11 include a generic portable information terminal such as a smartphone.

The remote control system 10 includes an electronic key 12. The electronic key 12 is also a device adapted to be carried by the user 20. The electronic key 12 is a wireless communication device capable of causing a control device 31 installed in the vehicle 30 to control the operation of the locking/unlocking device 32 based on first wireless communication. The locking/unlocking device 32 is a device for locking/unlocking a door 34 for opening/closing a cabin 33 of the vehicle 30. The vehicle 30 is an example of a mobility. The locking/unlocking device 32 is an example of a first controlled device.

The first wireless communication includes transmitting and receiving a first signal S1 using a first frequency band and a second signal S2 using a second frequency band. The first frequency band and the second frequency band are different from each other. Examples of the first frequency band include a low frequency (LF) band. Examples of the second frequency band include an ultra high frequency (UHF) band. In other words, the electronic key 12 outputs information necessary for controlling the locking/unlocking device 32.

Specifically, a first signal S1 is transmitted through a communication device disposed at an appropriate position in the vehicle 30. The transmission of the first signal S1 may be performed continuously or intermittently. The electronic key 12 includes a communication device including an antenna capable of receiving the first signal S1 and transmitting the second signal S2. The electronic key 12 is configured to transmit the second signal S2 upon receiving the first signal S1. The second signal S2 is configured to include authentication information required for the authentication of the electronic key 12. The authentication information is information capable of specifying at least one of the electronic key 12 and the user 20.

The control device 31 is configured to execute authentication processing upon reception of the second signal S2 through a communication device disposed at an appropriate position in the vehicle 30. Specifically, the control device 31 is configured to match the authentication information included in the second signal S2 with authentication information of the electronic key 12 stored in a storage device (not illustrated) in advance. When the matching degree between the two pieces of information exceeds a threshold value, the control device 31 determines that the authentication of the electronic key 12 is approved.

When it is determined that the authentication of the electronic key 12 is approved, the control device 31 is configured to output a control signal CS for causing the locking/unlocking device 31 to perform the locking/unlocking operation. For example, the locking/unlocking device 32 may be configured to perform the locking/unlocking of the door 34 when the user 20 touches a touch sensor provided on the door handle in a state that the authentication of the electronic key 12 is approved.

In other words, when the user 20 carrying the electronic key 12 enters an area capable of receiving the first signal S1, the authentication of the electronic key 12 is performed through the first wireless communication. When the authentication is approved, the user 20 can lock/unlock the door 34 without performing an operation such as inserting and rotating a key into a key cylinder.

The remote control system 10 includes a housing device 13. The housing device 13 is configured to be disposed at an appropriate position in the vehicle cabin 33 of the vehicle 30. The location may include a storage space such as a glove box or an accessory box disposed in the vehicle cabin 33. The housing device 13 is configured to house the electronic key 12. In other words, the electronic key 12 can be disposed in the vehicle cabin 33. The vehicle cabin 33 is an example of a space in which the housing device 13 is disposed. The door 34 is an example of a reclosable body for opening/closing a space in which the housing device 13 is disposed.

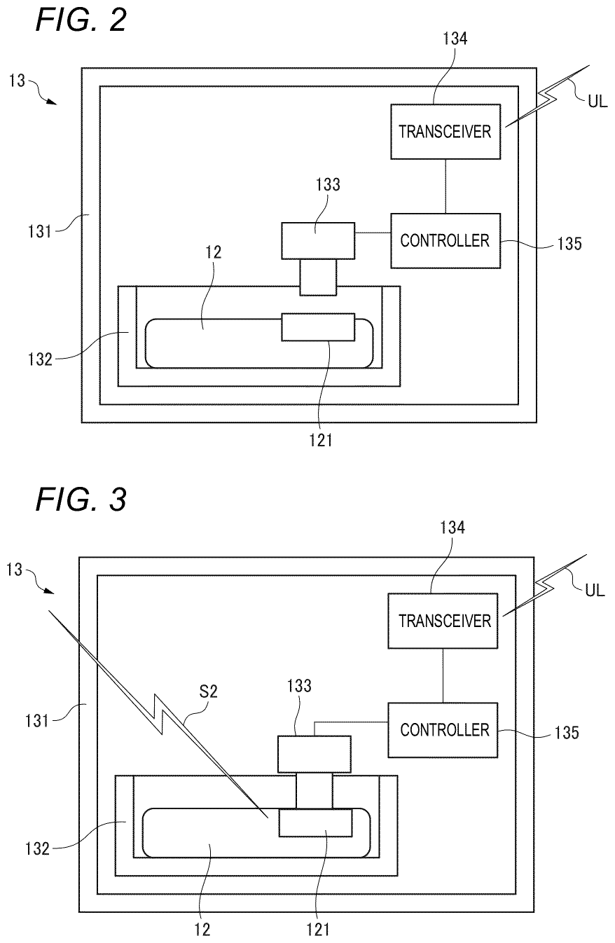

As illustrated in FIG. 2, the housing device 13 includes a housing 131. The housing 131 is formed of a material capable of transmitting at least the second signal S2. The housing 131 defines a space in which the electronic key 12 is housed.

Specifically, the housing device 13 includes a tray 132. The electronic key 12 may be disposed in the tray 132. The configuration of the tray 132 will be described later in detail.

The housing device 13 includes a first actuator 133. The first actuator 133 is configured to actuate a movable portion 121 of the electronic key 12 housed in the tray 132. The electronic key 12 is configured to transmit the second signal S2 when a prescribed actuation is performed with respect to the movable member 121, regardless of the reception state of the first signal S1. The movable portion 121 can be implemented by a button, a lever, or the like. Examples of the operation of the movable portion 121 for causing the electronic key 12 to transmit the second signal S2 include a long-press operation exceeding a prescribed time length, and the like.

The housing device 13 includes a transceiver 134. The transceiver 134 includes an antenna for performing second wireless communication with a mobile device 11. In this example, the second wireless communication is short-range wireless communication.

As used herein, the term “short-range wireless communication” means wireless communication performed in accordance with standard IEEE 802.15 or IEEE 802.11. Examples of the technology capable of executing such wireless communication include Bluetooth (registered trademark), Bluetooth Low Energy (registered trademark), UWB (Ultra Wide Band), ZigBee (registered trademark), and Wi-Fi (registered trademark). As used herein, the term “short-range wireless communication” is distinguished from “near field wireless communication” performed with a non-contact communication technique in which a mobile device transmits information upon reception of minute power from a radio wave transmitted from a reading device. Examples of the technique capable of executing the near field wireless communication include an RF-ID and an NFC.

A user, who wishes to unlock the door 34 of the vehicle 30 under the condition that the electronic key 12 is housed in the housing device 13, performs a prescribed actuation with respect to the mobile device 11. The actuation can be performed by an actuation with respect to a switch or a switch image, an audio instruction input, a gesture input, or the like. As illustrated in FIG. 1, the mobile device 11 is configured to transmit an unlock signal UL based on the prescribed actuation.

As illustrated in FIG. 2, the housing device 13 includes a controller 135. The controller 135 is configured to control the operation of the first actuator 133. Specifically, as illustrated in FIG. 3, the controller 135 is configured to cause the first actuator 133 to perform an actuation of the movable portion 121 for causing the electronic key 12 to transmit the second signal S2 when the transceiver 134 receives the unlock signal UL. In other words, in response to the reception of the unlock signal UL by the transceiver 134, the second signal S2 is transmitted from the electronic key 12.

The second signal S2 transmitted from the electronic key 12 is received by the control device 31 installed in the vehicle 30. As described above, in response to the reception of the second signal, the control device 31 performs the authentication processing of the electronic key 12. When the authentication is approved, the control device 31 outputs a control signal CS for causing the locking/unlocking device 32 to unlock the door 34.

Accordingly, when the user 20 transmits the unlock signal UL from the mobile device 11 in a state where the electronic key 12 is housed in the housing device 13 disposed in the vehicle cabin 33, the door 34 can be unlocked. In other words, the user 20 can unlock the door 34 with a prescribed operation with respect to the mobile device 11 from outside the vehicle cabin 33 without carrying the electronic key 12.

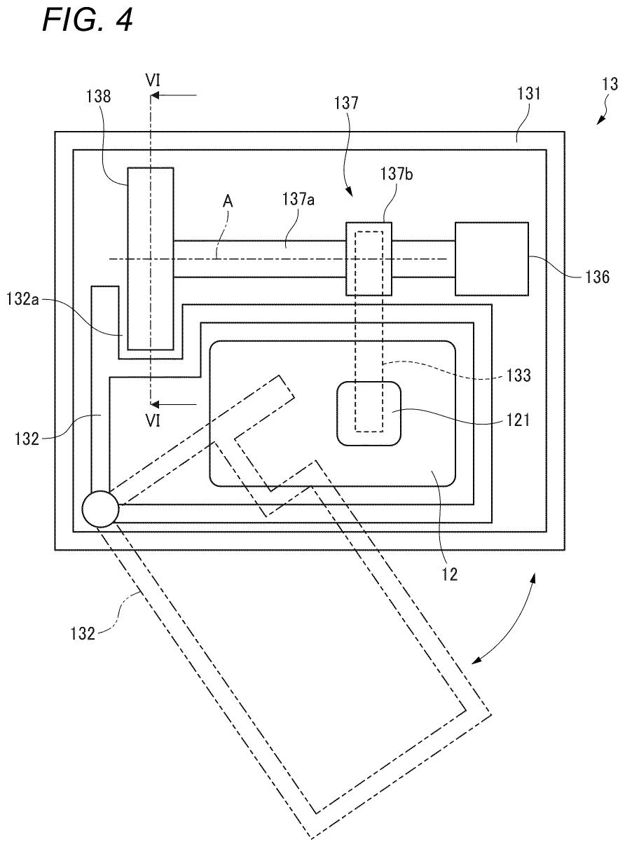

As illustrated in FIG. 4, the housing device 13 includes a motor 136 and a cam mechanism 137. The cam mechanism 137 includes a rotary shaft 137a and a cam 137b. The rotary shaft 137a is coupled to the motor 136 so as to be rotatable about the axis A. The cam 137b is mechanically coupled to the first actuator 133. As a result, the first actuator 133 can serve as a cam follower.

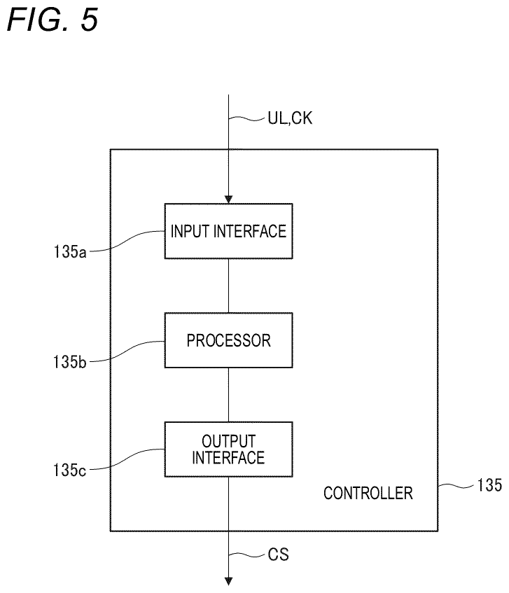

As illustrated in FIG. 5, the controller 135 includes an input interface 135a. The input interface 135a is configured as a hardware interface for receiving the unlock signal UL from the transceiver 134. The unlock signal UL may be an analog signal or a digital signal. In a case where the unlock signal UL is an analog signal, the input interface 135a is provided with an appropriate conversion circuit including an A/D converter. This description may be similarly applied to another signal or data capable of being received by the input interface 135a.

The controller 135 includes a processor 135b and an output interface 135c. The processor 135b is configured to output a drive signal DS for driving the motor 136 from the output interface 135c in response to the reception of the unlock signal UL by the input interface 135a. In accordance with the drive signal DS, the motor 136 operates the cam mechanism 137 so as to cause the first actuator 133 to actuate the movable portion 121 for causing the electronic key 12 to transmit the second signal S2.

In other words, the output interface 135c is configured as a hardware interface capable of outputting the drive signal DS. The drive signal DS may be an analog signal or a digital signal in accordance with the specification of the motor 136 In a case where the drive signal DS is the analog signal, the output interface 135c is provided with an appropriate conversion circuit including a D/A converter.

As illustrated in FIG. 4, the tray 132 of the housing device 13 is configured to be movable between a closed position in which the electronic key 12 is housed in the housing 131 and an opened position in which the electronic key 12 is exposed outside the housing 131. In FIG. 4, the closed position is illustrated with solid lines, whereas the opened position is illustrated with dashed chain lines. When the tray 132 is in the opened position, the user 20 can remove the electronic key 12 from the tray 132.

As illustrated in FIG. 1, a starter device 35 is installed in a vehicle 30. The starter device 35 is a device for activating a driving source of the vehicle 30. The driving source may include at least one of an internal combustion engine and an electric motor. By removing the electronic key 12 from the tray 132, the control device 31 is enabled to perform the operation control of the starter device 35. In other words, by opening the tray 132, the electronic key 12 is enabled to be removed from the housing 131 to use the starter device 35. The tray 132 is an example of a reclosable body. The starter device 35 is an example of a second controlled device.

As illustrated in FIG. 4, the housing device 13 includes a second actuator 138. The second actuator 138 is disposed in the housing 131. The second actuator 138 is configured to enable or disable the tray 132 to be opened.

Specifically, the second actuator 138 is configured to be movable between a state where it is engaged with a recess 132a provided in the tray 132 placed in the closed position, and a state where it is not engaged with the recess 132a.

For example, the housing device 13 may be equipped with a locking mechanism (not illustrated) for locking the tray 132 in the closed position, as well as an urging mechanism (not illustrated) for constantly urging the tray 132 toward the opened position. In a case where a prescribed operation is performed with respect to the housing device 13 under a condition that the second actuator 138 is not engaged with the recess 132a, the locking performed by the locking mechanism is canceled, so that the tray 132 is moved to the opened position by the urging force of the urging mechanism.

On the other hand, under a condition that the second actuator 138 is engaged with the recess 132a, even if the locking performed by the locking mechanism is canceled, the displacement of the tray 132 to the opened position is prevented.

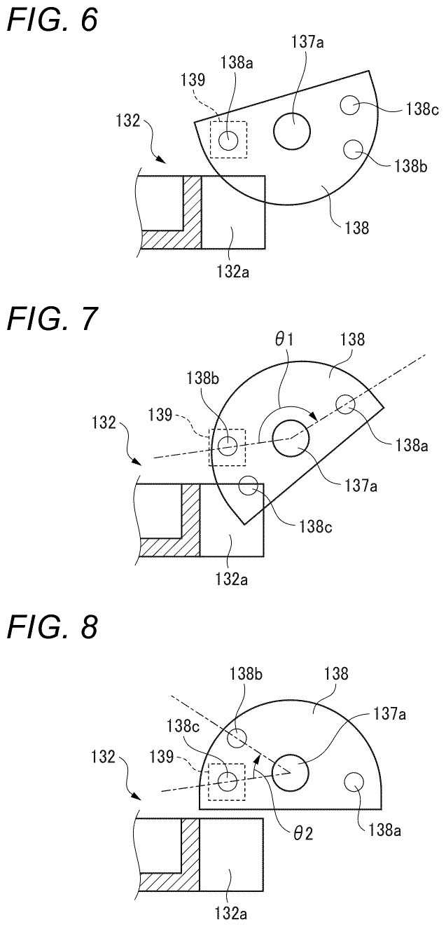

FIG. 6 illustrates a cross section of a portion of the housing device 13 viewed from an arrowed direction along the line VI-VI in FIG. 4. In this exemplary embodiment, the second actuator 138 is coupled to the rotary shaft 137a of the cam mechanism 137. Accordingly, the second actuator 138 rotates about the axis A in accordance with the motion of the cam mechanism 137 caused by the motor 136.

The shape of the second actuator 138 viewed from the direction along the axis A is determined so as to take a state where a part of the second actuator 138 enters into the recess 132a of the tray and a state where no part of the second actuator 138 is located in the recess 132a, in accordance with the rotation about the axis A.

In a state where a part of the second actuator 138 enters the recess 132a as illustrated in FIGS. 6 and 7, the displacement of the tray 132 to the opened position is prevented. In a state where no part of the second actuator 138 is located in the recess 132a as illustrated in FIG. 8, the tray 132 is allowed to be displaced to the opened position.

As illustrated in FIG. 1, the remote control system 10 includes an alcohol detector 14. The alcohol detector 14 is a device for detecting concentration of alcohol contained in exhaled air of the user 20. The alcohol detector 14 may be disposed at a location remote from the vehicle 30, or may be installed in the vehicle 30.

The alcohol detector 14 is configured to output check data CK indicating whether the user 20 is under the influence of alcohol based on the detected alcohol concentration. The check data CK may be in the form of analog data or may be in the form of digital data. When the alcohol concentration contained in the exhaled air of the user 20 is no less than a threshold value, the user 20 is considered to be under the influence of alcohol. The check data CK may include, as information, the detected alcohol concentration itself, or may include information indicating whether or not the person is under the influence of alcohol.

The input interface 135a of the controller 135 is configured to receive the check data CK from the alcohol detector 14.

In a case where the alcohol detector 14 is located at a location remote from the vehicle 30, the mobile device 11 may receive the check data CK from the alcohol detector 14 via the wireless communication network 40. The wireless communication network 40 is a network capable of performing wireless communication according to standards such as LTE (Long Term Evolution), 4G, 5G, and Wi-Fi (registered trademark). In this case, the input interface 135a may receive the check data CK via the mobile device 11.

Alternatively, the communication device 36 installed in the vehicle 30 may receive the check data CK from the alcohol detector 14 via the wireless communication network 40. In this case, the input interface 135a may receive the check data CK via short-range wireless communication or wired communication with the communication device 36. In a case where the alcohol detector 14 is installed in the vehicle 30, the input interface 135a may receive the check data CK via short-range wireless communication or wired communication with the alcohol detector 14.

In a case where the check data CK received by the input interface 135a indicates that the user 20 is not under the influence of alcohol, the processor 135b of the controller 135 outputs, from the output interface 135c, a drive signal DS for driving the motor 136 so as to cause the second actuator 138 to perform an operation for allowing the tray 132 to be displaced to the opened position. The fact that the user 20 is not under the influence of alcohol is an example of a fact that the requirement for use of the electronic key 12 is satisfied.

In other words, when the check data CK indicates that the user 20 is under the influence of alcohol, the processor 135b maintains a state where the displacement of the tray 132 to the opened position is prevented by the second actuator 138. The user 20 cannot remove the electronic key 12 from the housing 131, so that the activation of the vehicle 30 is disabled.

As illustrated in FIG. 6, the housing device 13 includes a magnetic sensor 139. On the other hand, the second sensor 138 is provided with a first magnet 138a, a second magnet 138b, and a third magnet 138c.

The position of the first magnet 138a is determined such that the magnetic sensor 139 detects the magnetism of the first magnet 138a when the second actuator 138 is placed in a rotary angular position illustrated in FIG. 6.

The position of the second magnet 138b is determined such that the magnetic sensor 139 detects the magnetism of the second magnet 138b when the second actuator 138 is placed in a rotary angular position illustrated in FIG. 7.

The position of the third magnet 138c is determined such that the magnetic sensor 139 detects the magnetism of the third magnet 138c when the second actuator 138 is placed in a rotary angular position illustrated in FIG. 8.

The magnetic sensor 139 is configured to output a detection signal to the controller 135 when it detects the magnetism of any of the first magnet 138a, the second magnet 138b, and the third magnet 138c. The processor 135b is configured to stop the driving of the motor 136 when the detection signal is received by the input interface 135a. As a result, the second actuator 138 can be stopped at an intended position.

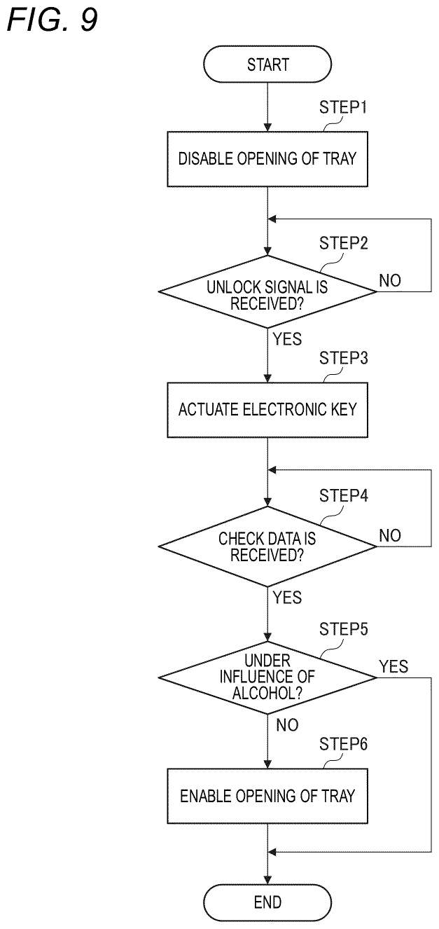

An exemplary processing executed by the processor 135b configured as described above will be described with reference to FIG. 9. This processing is initiated when the tray 132 in which the electronic key 12 is housed is placed at the closed position.

First, the processor 135b outputs, from the output interface 135c, a drive signal DS for driving the motor 136 so as to cause the second actuator 138 to disable the tray 132 to be disabled to the opened position (STEP1).

Specifically, the rotary shaft 137a of the cam mechanism 137 is rotated so that the second actuator 138 assumes the rotary angular position illustrated in FIG. 6. In response to the detection of the magnetism of the first magnet 138a attached to the second actuator 138 by the magnetic sensor 139, the processor 135b stops the driving of the motor 136.

Subsequently, the processor 135b determines whether an unlock signal UL is received by the input interface 135a (STEP2). The processing is repeated until it is determined that the unlock signal UL is received (NO in STEP2).

In response to the determination that the unlock signal UL is received by the input interface 135a (YES in STEP2), the processor 135b outputs a drive signal DS for driving the motor 136 so as to cause the first actuator 133 to actuate the movable portion 121 of the electronic key 12 from the output interface 135c (STEP3).

In this exemplary embodiment, the rotation of the rotary shaft 137a for displacing the second actuator 138 from the rotary angular position illustrated in FIG. 6 to the rotary angular position illustrated in FIG. 7 is so configured as to correspond to the movement of the cam 137b for causing the first actuator 133 to perform a prescribed actuation with respect to the movable portion 121 of the electronic key 12.

Accordingly, the rotary shaft 137a of the cam mechanism 137 is rotated such that the second actuator 138 assumes the rotary angular position illustrated in FIG. 7. In response to the detection of the magnetism of the second magnet 138b attached to the second actuator 138 by the magnetic sensor 139, the processor 135b stops the driving of the motor 136.

As a result, the second signal S2 is transmitted from the electronic key 12. The control device 31 of the vehicle 30 causes the locking/unlocking device 32 to unlock the door 34 in accordance with the second signal S2. In other words, the door 34 is unlocked while the displacement of the tray 132 to the opened position is disabled. Although the user 20 can enter the vehicle cabin 33, the electronic key 12 cannot be removed from the housing 131.

Subsequently, the processor 135b determines whether check data CK is received by the input interface 135a (STEP4). The processing is repeated until it is determined that the check data CK is received (NO in STEP4). In other words, the electronic key 12 cannot be removed from the housing 131 unless the user 20 is subjected to the alcohol check.

In response to the determination that the check data CK is received by the input interface 135a (YES in STEP4), the processor 135b determines whether the user 20 is under the influence of alcohol based on the check data CK (STEP5). In a case where the check data CK indicates the value of the detected alcohol concentration, the determination is made based on whether the value is no less than a prescribed threshold value. In a case where the check data CK already includes information about whether the user 20 is under the influence of alcohol, the determination is made by referring to the information.

In response to the determination that the user 20 is not under the influence of alcohol (NO in STEP5), the processor 135b outputs, from the output interface 135c, a drive signal DS for driving the motor 136 so as to cause the second actuator 138 to enable the displacement of the tray 132 to the opened position (STEP6).

Specifically, the rotary shaft 137a of the cam mechanism 137 is rotated such that the second actuator 138 assumes the rotary angular position illustrated in FIG. 8. In response to the detection of the magnetism of the third magnet 138c attached to the second actuator 138 by the magnetic sensor 139, the processor 135b stops the driving of the motor 136.

As a result, the user 20 can remove the electronic key 12 from the housing 131 so that the starter device 35 is enabled to activate the vehicle 30.

In response to the determination that the user 20 is under the influence of alcohol (YES in STEP5), the processor 135b terminates the processing. In other words, it is maintained a state where the displacement of the tray 132 to the opened position is disabled. The user 20 cannot remove the electronic key 12 from the housing 131, nor can the vehicle 30 be activated.

According to the configuration of this exemplary embodiment, since the opening of the tray 132 is disabled in a case where the user 20 is under the influence of alcohol, the electronic key 12 cannot be removed from the housing 131, so that the starter device 35 can be restricted from being used by the user 20. On the other hand, even in a state where the opening of the tray 132 is disabled, since the actuation of the movable portion 121 of the electronic key 12 by the first actuator 133 is allowed, the unlocking of the door 34 by the locking/unlocking device 32 is performed regardless of whether the user 20 is under the influence of alcohol, so that the entry into the vehicle cabin 33 is permitted. As a result, it is possible to alleviate the restriction as for the way of using the electronic key 12 associated with the use of the locking/unlocking device 32 and the starter device 35. For example, it is possible to avoid the occurrence of a situation where the user 20 who wishes to enter the vehicle cabin 33 due to an evacuation from a bad weather or the like is not permitted to unlock the door 34 because of the influence of alcohol.

In addition, it is possible to dispose the alcohol detector 14 in the vehicle cabin 33, so that the alcohol concentration check can be performed in the vehicle cabin 33. As a result, not only it is possible to enhance the flexibility as for the location where the alcohol detector 14 is disposed, but also it is possible to obtain a check result that is closer to the current condition of the user 20 who wishes to use the vehicle 30.

Accordingly, it is possible to enhance the convenience of the housing device 13 equipped with the housing 131 for defining a space in which the electronic key 12 associated with the use of the locking/unlocking device 32 and the starter device 35 in the vehicle 30 is housed.

As illustrated in FIG. 7, the rotation angle of the rotary shaft 137a from the rotary angular position of the second actuator 138 for disabling the displacement of the tray 132 to the opened position under the condition that the unlock signal UL is not received to the rotary angular position of the second actuator 138 for disabling the displacement of the tray 132 to the opened position under the condition that the unlock signal UL is received is θ1. As illustrated in FIG. 8, the rotation angle of the rotary shaft 137a from the rotary angular position of the second actuator 138 for disabling the displacement of the tray 132 to the opened position under the condition that the unlock signal UL is received to the rotary angular position of the second actuator 138 for enabling the displacement of the tray 132 to the opened position is θ2. The angle θ2 is smaller than the angle θ1.

The state illustrated in FIG. 7 corresponds to a state where the result of the alcohol concentration check is awaited under the condition that the unlocking of the door 34 is allowed. By completing the rotation with the angle θ1 while the awaiting period, it is possible to reduce the amount of displacement of the second actuator 138 required for enabling the opening of the tray 132 after the determination that the user 20 is not under the influence of alcohol. As a result, it is possible to shorten the time required for enabling the use of the electronic key 12, so that it is possible to suppress an uncomfortable feeling that would be imparted to the user 20.

The processor 135b having various functions described above can be implemented by an integrated circuit element such as a microcontroller, an ASIC, and an FPGA.

Each configuration described above is merely illustrative for facilitating understanding of the presently disclosed subject matter. Each of the above exemplary configurations can be appropriately modified or combined with another exemplary configuration within the teaching of the presently disclosed subject matter.

In the above exemplary embodiment, the second actuator 138 constitutes a part of a cam mechanism 137 for causing the first actuator 133 to actuate the movable portion 121 of the electronic key 12. According to such a configuration, it is possible to suppress an increase in the number of components.

However, as long as the processing described with reference to FIG. 5 can be executed, the operation of the second actuator 138 can be controlled by the controller 135 through a mechanism independent of the cam mechanism 137. Each of the first actuator 133 and the second actuator 138 may be configured by a solenoid or a rack-and-pinion mechanism.

In the above exemplary embodiment, an intended rotary angular position of the second actuator 138 is detected by the magnetic sensor 139. According to such a configuration, the intended rotary angular position can be detected with a relatively simple and inexpensive configuration.

However, the rotation angle of the rotary shaft 137a may be detected with a rotary encoder. Alternatively, a configuration in which a light-blocking condition is changed in accordance with the rotation may be applied to the second actuator 138, so that the rotary angular position may be detected with a photo-interrupter.

In the above exemplary embodiment, the first wireless communication performed between the control device 31 and the electronic key 12 uses different frequency bands. However, the first wireless communication may be performed in accordance with an appropriate wireless communication standard using an identical frequency band.

In the above exemplary embodiment, the second wireless communication performed between the mobile device 11 and the transceiver 134 of the housing device 13 is the short-range wireless communication. In this case, it is possible to enhance the flexibility as for the location where the housing device 13 is disposed in the vehicle cabin 33. However, the second wireless communication may be the near field wireless communication.

In the above exemplary embodiment, the door 34 for opening and closing the vehicle cabin 33 is exemplified as the reclosable body to be locked/unlocked by the locking/unlocking device 32. The form of the door 34 may be a hinged door as illustrated in FIG. 1, or may be a slidable door. The reclosable body adapted to be installed in the vehicle 30 may include a trunk and a bonnet. In this case, the housing device 13 may be disposed in a space opened and closed by a trunk or a bonnet.

The remote control system 10 according to the presently disclosed subject matter may be applied to other mobilities that require restrictions on the use because of the influence of alcohol. Examples of another mobilities include railways, aircraft, and ships. The type of controlled device whose use via a portable device housed in the housing device 13 is restricted is appropriately determined according to the specification of the mobility.

The condition under which the use of the controlled device via the portable device housed in the housing device 13 is restricted is not limited to the influence of alcohol. The detection of drowsiness, disturbance of consciousness, abnormal behavior, and the like with respect to the user 20 may also be an example of the condition. In this case, in addition to or in place of the alcohol detector 14, a facility for detecting the abnormality is disposed in an appropriate location.

The reclosable body to be locked/unlocked by the locking/unlocking device may not be installed in the mobility. Doors and windows in facilities requiring restrictions on the use because of the influence of alcohol may also be an example of the reclosable body. The type and condition of another controlled device whose use via the portable device housed in the housing device 13 is restricted are appropriately determined according to the specification of the facility.

Items listed below also constitutes a part of the presently disclosed subject matter:

Item 1: A housing device, comprising:
a housing defining a space in which a portable device for remotely controlling a first controlled device with actuation of a movable member is to be housed;
a reclosable body configured to be opened to enable the portable device removed from the space to use a second controlled device;
a first actuator disposed in the housing, and configured to actuate the movable member of the portable device housed in the space;
a second actuator disposed in the housing, and configured to enable/disable opening of the reclosable body;
an interface configured to receive, via wireless communication, an instruction transmitted from a mobile device adapted to be carried by a user as well as data indicative of whether the user satisfies a requirement for use of the second controlled device; and
a processor configured to control operations of the first actuator and the second actuator in accordance with at least one of the instruction and the data,
wherein the processor is further configured to:
   cause the first actuator to actuate the movable portion while causing the second actuator to disable the opening of the reclosable body in a case where the interface receives the instruction; and
   cause the second actuator to enable the opening of the reclosable body in a case where the data is indicative of a fact that the user satisfies the requirement for use.

Item 2: The housing device according to item 1, wherein the second actuator is a part of a cam mechanism configured to cause the first actuator to actuate the movable portion.

Item 3: The housing device according to item 2, wherein the cam mechanism includes a rotary shaft configured to be rotated about an axis;
wherein the second actuator is configured to be rotated with the rotary shaft to assume:
   a first rotary angular position where disables the opening of the reclosable body under a condition that the instruction is not received;
   a second rotary angular position where disables the opening of the reclosable body under a condition that the instruction is received; and
   a third rotary angular position where enables the opening of the reclosable body; and
wherein an angle from the second rotary angular position to the third rotary angular position is smaller than an angle from the first rotary angular position to the second rotary angular position.

Item 4: The housing device according to item 3, further comprising:
a magnetic sensor configured to detect the first rotary angular position, the second rotary angular position, and the third rotary angular position.

Item 5: The housing device according to any one of items 1 to 4,
wherein the first controlled device is a locking/unlocking device configured to lock/unlock a reclosable body for opening/closing a space in which the housing device is to be disposed.

Item 6: The housing device according to item 5,
wherein the reclosable body is installed in a mobility; and
wherein the second controlled device is a starter device configured to activate a driving source of the mobility.

Item 7: The housing device according to any one of items 1 to 6, wherein the requirement for use includes not being under influence of alcohol.

1. A housing device, comprising:
a housing defining a space in which a portable device for remotely controlling a first controlled device with actuation of a movable member is to be housed;
a reclosable body configured to be opened to enable the portable device removed from the space to use a second controlled device;
a first actuator disposed in the housing, and configured to actuate the movable member of the portable device housed in the space;
a second actuator disposed in the housing, and configured to enable/disable opening of the reclosable body;
an interface configured to receive, via wireless communication, an instruction transmitted from a mobile device adapted to be carried by a user as well as data indicative of whether the user satisfies a requirement for use of the second controlled device; and
a processor configured to control operations of the first actuator and the second actuator in accordance with at least one of the instruction and the data,
wherein the processor is further configured to:
cause the first actuator to actuate the movable portion while causing the second actuator to disable the opening of the reclosable body in a case where the interface receives the instruction; and
cause the second actuator to enable the opening of the reclosable body in a case where the data is indicative of a fact that the user satisfies the requirement for use.

2. The housing device according to claim 1,
wherein the second actuator is a part of a cam mechanism configured to cause the first actuator to actuate the movable portion.

3. The housing device according to claim 2,
wherein the cam mechanism includes a rotary shaft configured to be rotated about an axis;
wherein the second actuator is configured to be rotated with the rotary shaft to assume:
a first rotary angular position where disables the opening of the reclosable body under a condition that the instruction is not received;
a second rotary angular position where disables the opening of the reclosable body under a condition that the instruction is received; and
a third rotary angular position where enables the opening of the reclosable body; and
wherein an angle from the second rotary angular position to the third rotary angular position is smaller than an angle from the first rotary angular position to the second rotary angular position.

4. The housing device according to claim 3, further comprising:
a magnetic sensor configured to detect the first rotary angular position, the second rotary angular position, and the third rotary angular position.

5. The housing device according to claim 1,
wherein the first controlled device is a locking/unlocking device configured to lock/unlock a reclosable body for opening/closing a space in which the housing device is to be disposed.

6. The housing device according to claim 5,
wherein the reclosable body is installed in a mobility; and
wherein the second controlled device is a starter device configured to activate a driving source of the mobility.

7. The housing device according to claim 1,
wherein the requirement for use includes not being under influence of alcohol.
